(19) United States
(12) Patent Application Publication
(10) Pub. No.: US 2009/0025183 A1
(43) Pub. Date: Jan. 29, 2009

(54) PULL-HANDLE ASSEMBLY

(75) Inventor: Dexuan CUI, Pointe-Claire (CA)

Correspondence Address: OGILVY RENAULT LLP, 1981 MCGILL COLLEGE AVENUE, SUITE 1600, MONTREAL, QC, H3A2Y3, CA

(73) Assignee: IDEAL SECURITY INC.

(21) Appl. No.: 11/828,379

(22) Filed: Jul. 26, 2007

(51) Int. Cl. E05B 1/00

(52) U.S. Cl. 16/412

(57) ABSTRACT

A handle assembly comprises a handle having a gripping portion to be handled to open a door. A base portion has a base pivot portion about which the handle pivots. The base portion transmits a pivoting motion of the; handle to a door-opening mechanism to open the door. A housing is securable against the door with an exposed side facing away from the door and a hidden side facing toward the door. The housing has a cavity being open to the hidden side. A front hole is defined in a surface of the exposed side of the housing and communicates with the cavity. The front hole is sized for the base portion to be entered in the cavity therethrough from the exposed side. A plug is insertable into the cavity of the housing from the hidden side to hold the base portion of the handle captive in the housing.

### FIELD OF THE APPLICATION

The present application relates to pull-handle assemblies, and more particularly to surface-mounted pull-handle assemblies of the type usually used with doors.

### BACKGROUND OF THE ART

Typical pull-handle assemblies usually include a handle which is pivotable about a transverse shaft provided within a housing, the housing being installed on a door. The handle is pulled by the user to pivot about the transverse shaft to activate a door-opening mechanism. The handle usually has a gripping portion extending out of a front hole of the housing, and a base portion connected to the gripping portion. The base portion is received within the housing to pivotally engage the transverse shaft, and is larger than the housing's front hole such as to be retained within the housing. As such, the gripping portion of the handle has to be small enough to pass through the front hole of the housing so that the housing and handle may be assembled.

### SUMMARY OF THE APPLICATION

It is therefore an aim of the present invention to provide a novel pull-handle assembly.

Therefore, in accordance with the present application, there is provided a handle assembly of the type used to actuate a door-opening mechanism, comprising: a handle having a gripping portion to be handled to open a door, and a base portion connected to the gripping portion and having a base pivot portion about which the handle pivots, the base portion transmitting a pivoting motion of the handle to a door-opening mechanism to actuate the door-opening mechanism to open the door; a housing securable against the door with an exposed side facing away from the door and a hidden side facing toward the door, the housing having a cavity being open to the hidden side, a front hole being defined in a surface of the exposed side of the housing and communicating with the cavity, the front hole being sized for the base portion to be entered in the cavity therethrough from the exposed side; and a plug insertable into the cavity of the housing from the hidden side to hold the base portion of the handle captive in the housing.

### BRIEF DESCRIPTION OF THE DRAWINGS

FIG. 1 is an assembly view of a pull-handle assembly constructed in accordance with an embodiment of the present invention;

FIG. 2 is a perspective view of a handle of the pull-handle assembly of FIG. 1;

FIG. 3 is a front perspective view of a housing of the pull-handle assembly of FIG. 1;

FIG. 4 is a rear perspective view of the housing of the pull-handle assembly of FIG. 1;

FIG. 5 is a perspective view of a plug of the pull-handle assembly of FIG. 1; and

FIG. 6 is a perspective view of the pull-handle assembly of FIG. 1, as mounted to a door.

### DESCRIPTION OF THE PREFERRED EMBODIMENTS

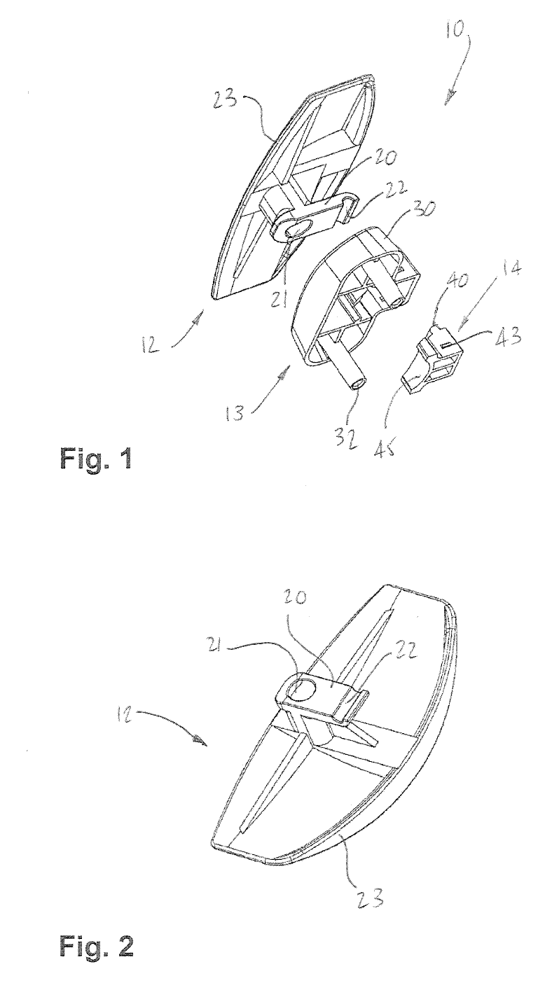

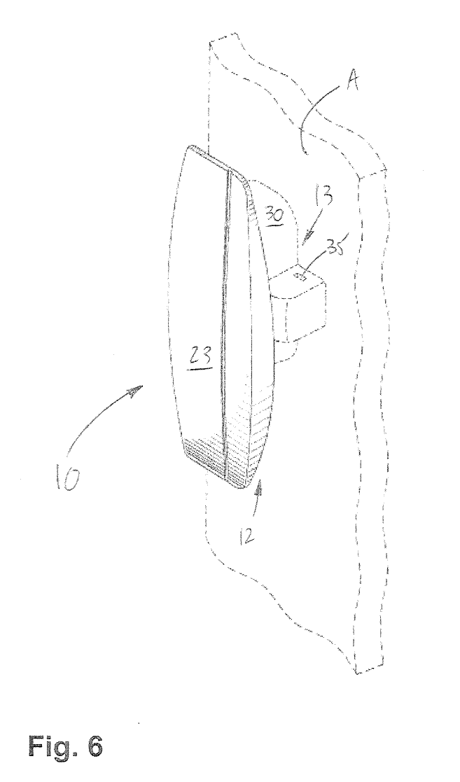

Referring now to the drawings, and more particularly to FIG. 1, a pull-handle assembly in accordance with an embodiment is generally shown at 10. The pull-handle assembly 10 has a handle 12, a housing 13 and a plug 14. The pull-handle assembly 10 is mounted to a door A, as is shown in FIG. 6, and is operatively related to a door-opening mechanism or the like (e.g., latch mechanism, dead-bolt mechanism, etc) to release a bolt from an engaged position in a door jamb to open the door.

The handle 12 is handled by a user person to open the door, and is operatively connected to a latch mechanism.

The housing 13 is the structural interface between the pull-handle assembly 10 and the door.

The plug 14 pivotally supports the handle 12, allowing the opening movement of the handle 12 with respect to the housing 13.

Referring to FIG. 1, the handle 12 is shown having a base portion 20. The base portion 20 is received in the housing 13, and must therefore be sized so as to fit into an opening of the housing 13, as described hereinafter.

The base portion 20 has a connector bore 21 that accommodates an end of a spindle of a door-opening mechanism, not shown in FIG. 1 but well known in the art. Outward movement of the spindle will result in a retraction of a bolt of the door-opening mechanism.

The base portion 20 also has a semicylindrical channel 22 that represents a base pivot portion, as it will be used for the pivoting movement of the handle 12.

The handle 12 also has a gripping portion 23. The gripping portion 23 is the portion of the handle 12 that is manually handled by a user person to open the door by releasing the bolt.

As it is the exposed portion of the handle 12, the gripping portion 23 has some esthetic features. In FIG. 6, one configuration of the gripping portion 23 is illustrated, but it is pointed out that the gripping portion 23 is not restricted to the ornamental configuration shown in this figure.

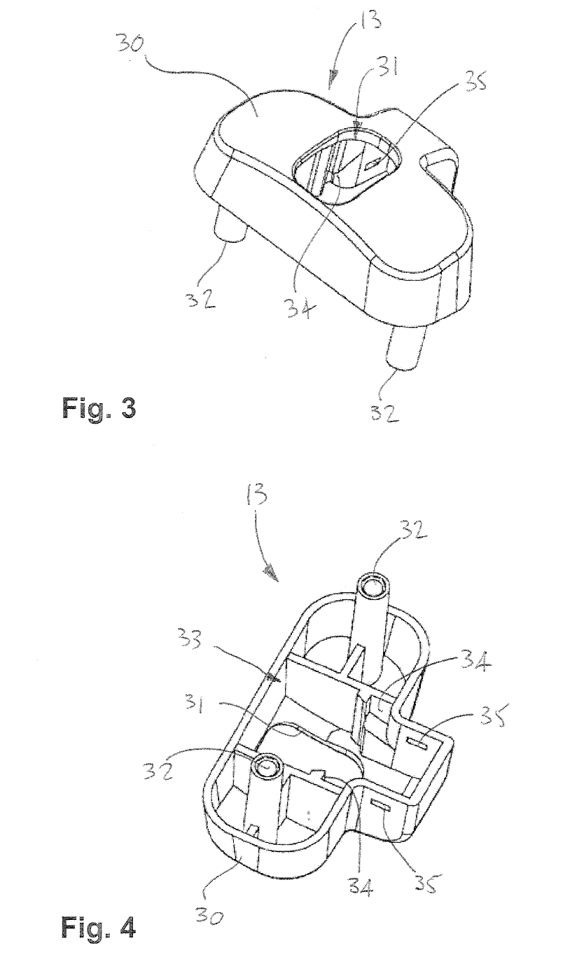

Referring concurrently to FIGS. 3 and 4, the housing 13 is shown in the form of a shell having an outer exposed surface 30. The exposed surface 30 is the portion of the housing 13 that is exposed on the door, as is seen in FIG. 6.

The exposed surface 30 has a front hole 31 through which the base portion 20 is inserted and supported by the housing 13. As discussed previously, the base portion 20 of the handle 12 must therefore be sized as a function of the front hole 31.

The housing 13 is connected to the door via screw holes 32. Although screw holes 32 are illustrated in FIG. 4, it is considered to use other connection means as well. For instance, the screw holes communicate with openings in a complementary handle housing on the other side of the door.

The front hole 31 is related to a cavity 33 in the housing 13. The cavity 33 is on the hidden side of the housing 13, as it will be facing toward the door when the housing 13 is mounted to the door. The cavity 33 accommodates a major portion of the base portion 20 when the handle 12 is assembled with the housing 13. Receptacles 34 are provided on either side of the cavity 33. Connector slits 35 are defined in opposed walls of the housing 13, within the cavity 33.

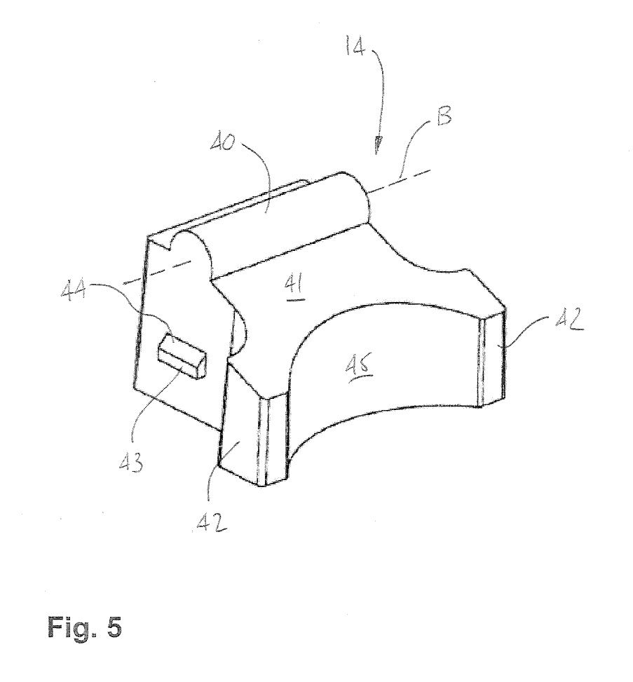

Referring to FIG. 5, the plug 14 is illustrated as having a body with a plug pivot portion 40. The plug 14 is received in the cavity 33 of the housing 13 (FIGS. 1 and 4). The plug pivot portion 40 has a shape that is complementary to the shape of the base pivot portion of the handle 12, namely a semicylindrical protrusion. Accordingly, when the handle 12 and the plug 14 are in operative contact (i.e., with the plug 14 accommodated in the cavity 33 of the housing 13), the plug pivot portion 40 is accommodated within the cylindrical channel 22 (the base pivot portion), such that the handle 12 is pivotable with respect to a longitudinal axis B of the plug pivot portion 40.

An abutment surface 41 projects from the pivot portion 40 and ramps downwardly, so as to define a clearance for the handle 12 to pivot. The abutment surface 41 limits the range of pivoting motion of the handle 12.

A pair of wings 42 are provided on both sides of the plug 14 and are accommodated in the receptacles 34 in the cavity 33 (FIG. 4). Therefore, the wings 42 provide additional stability when the plug 14 is in the cavity 33 of the housing 13. The wings 42 are captive between the surface of the cavity 33 and the surface of the door when the pull-handle assembly 10 is mounted to a door.

In the embodiment illustrated in FIGS. 1 to 5, the plug 14 is secured to the housing 13 by a pair of connector wedges 43, one of which is visible in FIG. 1, the other being visible in FIG. 5. The wedges 43 are received in the connector slits 35 (FIG. 4) of the housing 13. The wedges 33 have a ramp surface 44 oriented toward the housing 33, so as to facilitate the snap-fit engagement of the wedges 33 in the connector slits 35, while preventing their accidental withdrawal. Other connection means are also considered to secure the plug 14 to the housing 13, such as bolts, screws and the like.

A cylindrical clearance 45 is defined in the plug 14 adjacent to the abutment surface 41. The cylindrical clearance 45 is provided to allow free movement of the spindle of the door-opening mechanism (not shown) as actuated by the handle 12 or as biased against the handle 12.

In order to install the pull-handle assembly 10, the base portion 20 of the handle 12 is inserted into the cavity 33 through the front hole 31 of the housing 13. The plug 14 is thereafter snap-fitted into engagement in the cavity 33, with the wings 42 accommodated in the receptacles 34, and the connector wedges 43 engaging the connector slits 35 on either side of the plug 14.

Accordingly, once the plug 14 is secured to the housing 13, the base portion 20 of the handle 12 is captive in the housing 13, but is pivotable along the longitudinal axis B of the plug pivot portion 40. This pivoting motion of the handle 12 will be used to activate the spindle (not shown) into retracting a bolt of the door-opening mechanism (or other door-locking mechanism).

More specifically, now that it is assembled, the pull-handle assembly 10 is secured to the door A (FIG. 6), with the screw holes 32 engaging with fastener openings in a handle portion mechanism on the other side of the door, or with the screw holes 32 used with fasteners secured to the door A, amongst other possibilities. It is pointed out that the connector bore 21 is aligned with the spindle of the door-opening mechanism (not shown), for the transmission of a pulling action to the spindle to displace a bolt (not shown) of the door-opening mechanism. The spindle typically has a biasing mechanism to bias the spindle back to its original position when the handle 12 is released, thereby returning the bolt to an exposed position. Pushing actuations could be used as well, provided the door-opening mechanism (or equivalent) operates in pushing actuation as opposed to pulling actuation.

The use of a plug 14 advantageously allows the base portion 20 of the handle 12 to be inserted into the front hole 31 of the housing 13. The plug 14 then holds the handle 12 captive with respect to the housing 13, as opposed to the base portion performing that function. Therefore, the gripping portion 23 is not limited in size so as to pass through the front hole 31 from an interior of the housing 13. Accordingly, the esthetic configuration of the gripping portion 23 is not restricted by the size of the front hole 31.

Advantageously, the plug 14 is only accessed from the hidden side of the housing 13 (i.e., the side that is against the door), whereby the plug 14 cannot be tampered with from the outside when the pull-handle assembly 10 is mounted to a door.

In the illustrated embodiment, the plug 14 also provides a pivot portion (i.e., plug pivot portion 40) about which the handle 12 will pivot in actuating the door-opening mechanism. It is, however, considered to provide a pivot portion in the housing 13 to cooperate with the base pivot portion (e.g., the semicylindrical channel 22), with the plug 14 holding the handle 12 captive in the housing 13.

As is illustrated in FIG. 6, the pull-handle assembly 10 is mounted to the door A in such a way that the longitudinal axis B (FIG. 5) is generally upright. Accordingly, the handle 12 pivots about a generally vertical axis, and moves in a generally horizontal direction. It is however possible to have the handle 12 pivot about a horizontal axis, although this is not the case in FIG. 6.

I claim:

1. A handle assembly of the type used to actuate a door-opening mechanism, comprising:
a handle having a gripping portion to be handled to open a door, and a base portion connected to the gripping portion and having a base pivot portion about which the handle pivots, the base portion transmitting a pivoting motion of the handle to a door-opening mechanism to actuate the door-opening mechanism to open the door;
a housing securable against the door with an exposed side facing away from the door and a hidden side facing toward the door, the housing having a cavity being open to the hidden side, a front hole being defined in a surface of the exposed side of the housing and communicating with the cavity, the front hole being sized for the base portion to be entered in the cavity therethrough from the exposed side; and
a plug insertable into the cavity of the housing from the hidden side to hold the base portion of the handle captive in the housing.

2. The handle assembly according to claim 1, wherein the plug has a plug pivot portion cooperating with the base pivot portion of the handle to form a pivot therewith about which the handle pivots to actuate the door opening mechanism.

3. The handle assembly according to claim 2, wherein the base pivot portion is a semi-cylindrical channel and the plug pivot portion is a semi-cylindrical protuberance.

4. The handle assembly according to claim 1, wherein the plug has connectors so as to be snap-fitted into engagement with connector slits in the cavity of the housing.

5. The handle assembly according to claim 1, wherein the base portion has a connector bore to accommodate a spindle of the door opening mechanism.

6. The handle assembly according to claim 1, wherein the gripping portion has a shape preventing the gripping portion from passing through the front hole in the housing.

7. The handle assembly according to claim 1, wherein the plug has an abutment surface that limits a range of pivoting motion of the handle.

8. The handle assembly according to claim 1, wherein a pulling action on the handle opens the door.

9. The handle assembly according to claim 1, wherein the base pivot portion has a generally vertical axis about which the handle pivots.
